(19) United States
(12) Patent Application Publication
(10) Pub. No.: US 2013/0006874 A1
(43) Pub. Date: Jan. 3, 2013

(54) SYSTEM AND METHOD FOR PRESERVING CONTEXT ACROSS MULTIPLE CUSTOMER SERVICE VENUES

(75) Inventor: Reinhard KLEMM, Basking Ridge, NJ (US)

(73) Assignee: Avaya Inc, Basking Ridge, NJ (US)

(21) Appl. No.: 13/174,025

(22) Filed: Jun. 30, 2011

(51) Int. Cl. G06Q 10/00

(52) U.S. Cl. 705/304

(57) ABSTRACT

Disclosed herein are systems, methods, and non-transitory computer-readable storage media for preserving context across multiple customer service venues. A system configured to practice the method identifies a user profile of a user requesting customer service, generates a context based on the user profile, the request, and other relevant data. The system communicates with the user at a first customer service venue based on the context, and receives an indication of movement of the user from the first customer service venue to a second customer service venue. The system transfers the context to the second customer service venue, and communicates with the user at the second customer service venue based on the context. A customer service venue can be a knowledge base, a troubleshooting guide, a social network, an online virtual world, a text-based chat, a voice conversation, a video chat, a spoken dialog system, and an onsite visit.

### BACKGROUND

1. Technical Field

The present disclosure relates to customer service applications and more specifically to managing and preserving customer service context across different venues.

2. Introduction

Over the last few decades, customers seeking remote customer service have grown accustomed to the inconvenience of providing the same or similar information to multiple customer serviceagents, interactive voice response systems, online customer service applications, online help forums, and similar contact points between customers and customer service providers (customer service venues). For instance, suppose a customer C bought a product P, manufactured by companyM, from vendor V. After her purchase, C thinks that P is defective, and she seeks help in resolving the issue with the product. C logs into V's Web portal with her username and password combination, navigates to a user forum in the portal (venue 1) where users discuss their experiences and problems with the products and services that V sells, and enters a search query into the search box in the user forum that describes the problem she is encountering with P. Her search query returns a number of hits, i.e., contributions (postings) from other users of the forum that match C's search query, but none of them helps her solve her problem with P. However, several of the search hits suggest to visit M's customer support website (venue 2). C clicks on the hyperlink for M's customer support website and finds a search box there that allows her to search M's knowledge base. C re-enters the same query that she entered in the user forum search box of V's web portal. M's knowledge base search engine returns a number of web pages that match C's query. While none of these articles directly helps C with her problem with product P, they convince her to seek the assistance of a live customer service agent through an online chat application on M's website (venue 3). Once the application has loaded into C's browser, she is greeted by agent A1 from M's customer service operation. A1 asks C how he can help her, and C again enters a description of her problem with P. The chat between C and A1 is hampered by the long delays between consecutive chat messages and A1's lack of in-depth technical knowledge. Therefore, C decides to end the chat and call the technical hotline (venue 4) whose toll-free number is displayed on M's support web page. When a technical support representative A2 comes on the line, A2 asks C to state her name (to address her properly), phone number (in case they get disconnected), and a detailed description of the problem that she is calling about. After a discussion between the two, A2 concludes that P is probably defective but cannot help her exchange P because M did not sell P to her. Instead, A2 advises C to call the vendor of the product, company V. The call ends and C calls V's customer service number (venue 5). V's customer service agent A3 first asks C to identify herself through her name, address, and a combination of security questions. Then, A3 asks her for the reason for her call, and C responds with the description of her problem with P as well as what M's representative concluded about the defectiveness of P. This scenario highlights a number of shortcomings of existing customer service operations:

1. The customer has to manually find the various customer service venues that might possibly aid her in resolving her issue. There is no formalized, automated mechanism that would step C through the various venues, across different communication modalities and companies, and support her along the way, even if one venue directs C to another venue.

2. The customer has to repeatedly articulate various pieces of information, such as the detailed description of her problem with P and identifying information about herself.

3. As C moves from one venue to another, the new venue has no automatic knowledge of C's journey from the first venue to this one even though C's history could prove important. For example, suppose agent A3 needed to verify C's claim that P is defective to authorize a repair, exchange P, or issue a credit to C. If A3 knew that C talked to agent A2 from the manufacturer's customer service operation, A3 could call A2 and confirm that indeed A2 had concluded the product is defective.

Improvements to customer service can increase customer satisfaction and preserve a good public image for organizations providing customer service.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for preserving context across multiple customer service venues. For example, when a user contacts customer service via a first customer service venue, such as via telephone, and decides to switch to a second customer service venue of a different type, such as social network based customer support, the system can detect the change in customer service venue. Upon detection of the change in customer service venue, the system can determine a subset of the context associated with the first customer service venue that is applicable to the second customer service venue and transfer the subset of the context to the second customer service venue. This provides a more continuous and pleasing customer service experience. Additionally, this approach can save the user's time as well as the time of the various customer service agents. The different customer service venues can be operated by a single entity. Alternatively, some of the customer service venues can be operated by different entities, such as technical support subcontractors or third party support forums. A venue preserving server can track, preserve, and transfer customer context across venue boundaries.

The method is discussed in terms of a system implementing the method. The system identifies a user profile associated with a customer when the customer requests customer service. The system can identify the user profile by creating a new user profile or retrieving an existing user profile depending on whether the customer is a new customer or a returning customer. After identifying a user profile and a receiving a customer service request, the system generates or fetches a context based on the given information. The system communicates with the customer at the first customer based on the context. Either the system or the customer can initiate a move to a new customer service venue that has a different mode of interaction from the first venue. The communication at the second venue is also based on the context that has been preserved from the first venue.

The service can continue on to the third venue and beyond depending on the customer's need and the availability of the venues.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example context preservation architecture;

FIG. 3 illustrates an example context data structure; and

FIG. 4 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

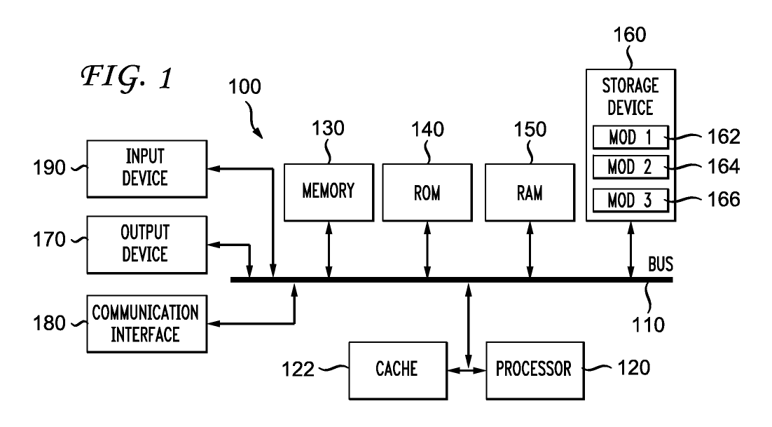

The present disclosure addresses the need in the art for improved customer service experience with a specific focus on how to preserve context across multiple customer service venues. A system, method and non-transitory computer-readable media are disclosed which creates and preserves a single context for a multi-venue customer service experience. Context can include, but is not limited to, personal identifying information, a customer service request, a customer service history, and other data relevant to customer service. A brief introductory description of a basic general purpose system or computing device in FIG. 1 which can be employed to practice the concepts is disclosed herein. A more detailed description of the method will then follow. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

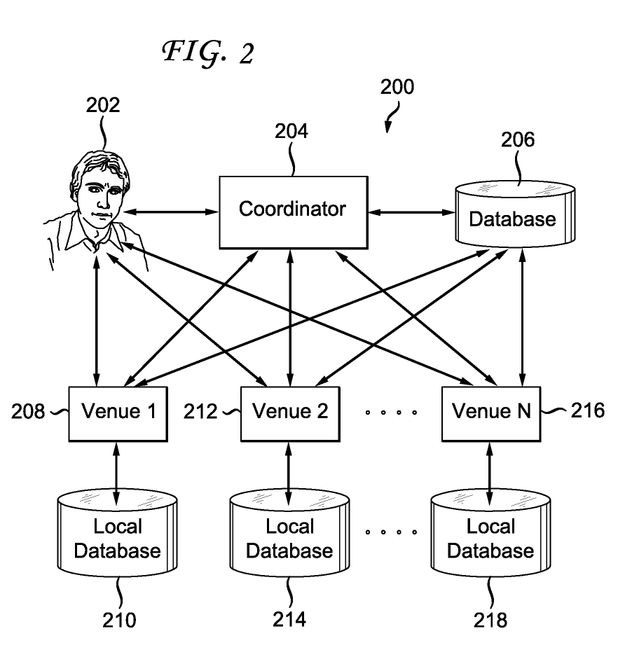

Having disclosed some components of a computing system, the disclosure now turns to FIG. 2, which illustrates an example context preservation architecture 200. In this architecture 200, a user 202 approaches a coordinator 204 or a customer service venue directly to initiate a customer service experience. The user can be a customer who is contacting customer support for the first time or a returning customer picking up where he left off or seeking help with an entirely new issue. The coordinator 204 can include, but is not limited to, a desktop application, a website, a mobile application, an application within a social network, a venue within an online virtual world, a kiosk, a spoken dialog system, and a software module. Optionally, the coordinator itself can be a customer service venue or incorporated as part of a customer service venue.

The coordinator 204 has access to a database 206 that may reside locally or on a network. The database 206 stores user profiles that are associated with each of the users 202. Optionally, the database can also store context for each customer service session for later retrieval such as one or more customer service requests, a customer service history, and any other data that can assist the system in better serving the user 202.

The coordinator 204 can cooperate closely with various customer service venues 208, 212, 216 and make the user profiles stored in the database 206 available to the first venue 208, the second venue 212, and all the way up to the Nth venue 216. The customer service venues can include, but are not limited to, a knowledge base, a troubleshooting guide, an online forum, a social network, a text-based chat, a voice conversation, a video chat, and an on-site visit. Some of these venues—a text-based chat, a voice conversation, and a video chat, for instance—involve a live human customer service agent or a automated machine such as a spoken dialog system. For example, a customer service venue can be a social network, where the description of the particular problem that the user is experiencing is posted up and other members can contribute to the solution of the problem in the form of “replies.” Any number of customer service venues can be used as part of the customer service experience 200.

The venues 208, 212, 216 can include their own local databases to store user profiles on a temporary, semi-permanent, or permanent basis. The extent to which each of these venues can access the user profiles can vary depending on the characteristics, privileges, and requirements of the venue. For instance, the coordinator may not grant privileges to a simple web-based troubleshooting service to access a customer's payment information or a social security number. In another example, a user may be given a choice to limit the amount and/or type of information that gets shared on a social media website that is listed as one of the customer service venues.

As the user 202 transitions through different customer service venues 208, 212, 216, the context can grow, shrink, or otherwise adapt. For example, as each venue gathers new pieces of information regarding a certain customer service request, such as how the product got damaged, what the symptoms are, and what types of preventative measures have been taken since, etc., the appropriate venue and/or the coordinator 204 can append appropriate descriptions of each to the context, so that the additional information becomes available to other customer service venues.

Each of the customer service venues 208, 212, 216 can interact with the user 202 through the coordinator 204. Alternatively, the venues 208, 212, 216 can interact directly with the user 202 and send indications to the coordinator 204 intermittently to notify the progress of the customer service and/or the status of the user profile. The venues 208, 212, 216 can communicate with the coordinator 204 to update the context when the user exits or is about to exit the venue. Once a customer service session with one venue is over, the user 202 may choose to terminate the customer service experience 200 if she feels that she has found an appropriate solution to her problem or she may end the customer service experience 200 prematurely for whatever reason (e.g., the user is not satisfied). Alternatively, the coordinator 204 or one of the venues 208, 212, 216 can terminate the experience 200 based on the availability of other customer service venues 208, 212, 216 or once it deems that an appropriate solution has been found for the user 202.

The order in which the system suggests or directs the customer 202 to different customer service venues 208, 212, 216, in its simplest form, can be implemented by a predetermined list. As an illustration, the system can be preconfigured to always send a user 202 to a troubleshooting guide first, a knowledge base second, a text-based chat support with a live customer service representative third, etc. In another embodiment, the user 202 may be given a choice as to which customer service venue that she wishes to be transferred to next after she is done interacting with one venue. In yet another embodiment, the system can adopt an automated algorithm, which can intelligently determine which venue would be the best fit for a given user. The user can also switch between venues without any guidance or prompting by the system. Optionally, the user may be presented with an opportunity to confirm the choice suggested by the algorithm.

Such an algorithm, for instance, can take advantage of a customer service history that is accumulated over time and intelligently predict the most likely order in which the venues produce satisfying results for a given user. This prediction can be a customized prediction based on just one user or a handful of individuals sharing similar interests. The prediction can be based on patterns observed among many users.

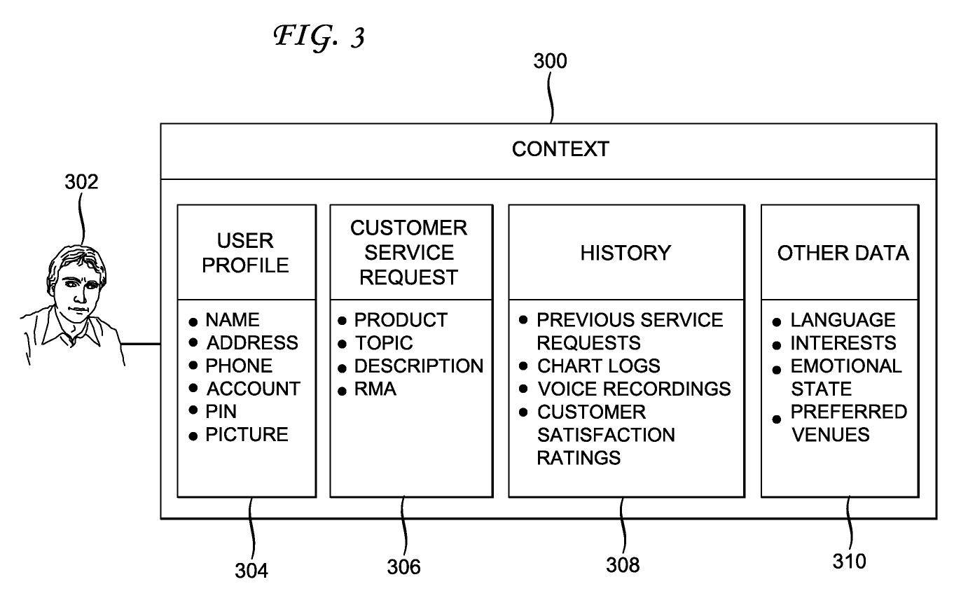

FIG. 3 illustrates an example context data structure. The exemplary data structure can tie each context 300 to one individual user 302. Context 300 can include, but is not limited to, a user profile 304, one or more customer service request 306, a customer service history 308, and any other data 310 that may be helpful to customer service.

The user profile 304 generally helps to identify a user or a group of users, such as a household, as a unique individual or group, and it can include, among other information, a name; an address; a phone number; account information (such as member ID, insurance policy number, bank account information, etc.); a personal identification number (PIN) and other security information; and a picture. Users can be associated with one or more user profiles.

The customer service request 306 contains information about a problem or an issue about which a user 302 has contacted the customer service agency. The customer service request 306 can include, but is not limited to, a product name, a general topic (e.g., billing, repairs, activation), a brief description of the problem, a detailed description of the problem, a name of the customer service agent handling the request, and other information related to the customer service request (e.g., service ticket number, return merchandize authorization (RMA) number). As the user 302 goes through different customer service venues 208, 212, 216, the system can modify the context as new information is appended to the customer service request.

The customer service history 308 contains a snapshot of all the interactions that the user 302 has had with various customer service venues. The snapshot can include, but is not limited to, previous service requests, chat logs, voice recordings (i.e., conversations with customer service agents), posts and replies on social media websites, knowledge base search results, and customer satisfaction ratings for previous customer service engagements. The information contained in the customer service history can help later customer service agents at different customer venues better understand their customers' backgrounds and expectations. The customer service history can also provide crucial clues to improve the system's prediction algorithm to come up with better venue suggestions.

Other data 310 that may be helpful to customer service can include, among others, the user's spoken language, interests, last-known emotional state (e.g., happy, mellow, irate, frustrated), preferred venue(s), and the level of technical expertise. These additional clues can affect the system operator or the algorithm in making a decision of what the most appropriate course of action is for a given user. In one embodiment, such information can affect the choice of venue. In another embodiment, such information can affect the way each venue handles its customers. For example, a customer who is known to have been very angry and frustrated at the last customer service venue can be treated differently—perhaps he can be paired up with a customer service representative who is known to have a good track record of dealing with unhappy customers or have received special training. In another example, a spoken dialog system can adjust its grammar for speech recognition or use different sets of terminology depending on the level of technical expertise or sophistication of its user. In yet another example, a spoken dialog system can default to the language spoken by its user without having to require a menu selection (i.e., “Para Español, oprima el número dos.”).

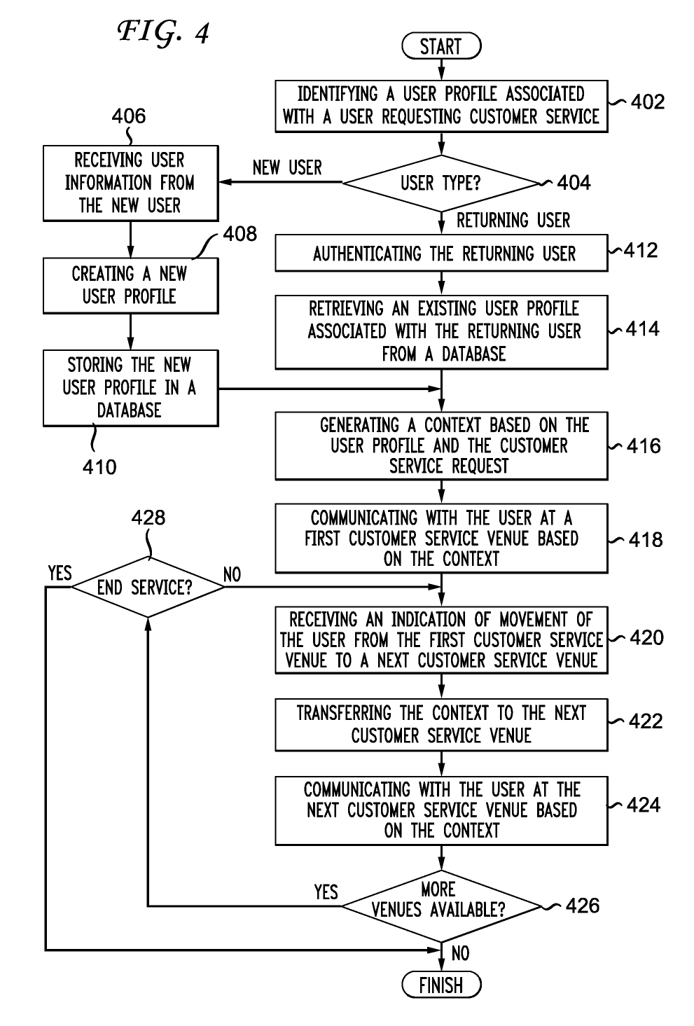

The disclosure now turns to the exemplary method embodiment shown in FIG. 4. For the sake of clarity, the method is discussed in terms of an exemplary system such as is shown in FIG. 1 configured to practice the method. The steps outlined herein are exemplary and can be implemented in any combination thereof, including combinations that exclude, add, or modify certain steps.

FIG. 4 illustrates an exemplary method embodiment for preserving single context across multiple customer service venues. The system 100 identifies a user profile associated with a user requesting customer service (402). The user is typically a customer who seeks customer service through the system 100. Identifying the user profile (402) can be a separate step or can include one or more of steps (404)-(414).

The system 100 determines if the user is a new user or a returning user (404). This can be done, for instance, by looking up the user's personal identifying information in the database 206, where all the personal profiles are stored, and searching for a match. The system can also tie in to other sources to determine whether the user is a new user or a returning user, such as checking for a Facebook cookie stored in a browser. If no such match is found and the user is determined to be a new user, the system 100 obtains additional user information from the new user (406) and creates a new user profile (408). The system 100 then stores the newly created user profile in a database (410). This database may reside locally as part of the system 100 or may be situated remotely and be accessible by the system 100 through a network.

However, if the system 100 determines that the user is not new, but in fact a returning customer (404), the system 100 can optionally authenticate the returning user (412). Various security measures can be employed at this step to ensure the correct identity of the returning user. Alternatively, the returning user can be automatically recognized, for instance, by means of facial recognition, voice recognition, fingerprint recognition, a phone number from which the user is calling, other biometric authentication, and so forth. Once the returning user is successfully recognized and authenticated, the system 100 retrieves from the database an existing user profile that corresponds to the user (414).

The system then generates or retrieves a context based on the user profile and the request for customer service (416). The context can include, but is not limited to, a user profile, a customer service request, a customer service history, and other relevant data that are helpful for customer service.

Based on this context, the system 100 communicates with the user at the first customer service venue (418) to conduct customer service activities, such as resolving or troubleshooting problems, receiving a service request, providing guidance, or conducting a return service authorization. In one embodiment, the user interacts directly with the venue. In another embodiment, the user interacts with the system 100, and the system 100 in turn acts as an intermediary between the user and the venue. The context can be directly accessible to the venue, or the system 100, acting as an intermediary, may serve the profile to the venue. In each case, each venue is able to modify or otherwise influence the contents of the context. Optionally, the degree to which the venue may modify or otherwise influence the context can vary depending on the permissions and privileges assigned to the venue. The customer service venue can be, among other things, a knowledge base, a troubleshooting guide, a social network, an online virtual world, a text-based chat, a voice conversation, a video chat, and an onsite visit.

The system 100 then receives an indication of movement of the user from the first customer service venue to the second customer service venue (420). The movement can be initiated by a user, by a customer service venue, or by the system 100. For instance, the user may decide that she wants to move on to another customer service venue, as she no longer needs assistance at the first venue. In another embodiment, the customer service venue may exhaust all of its resources and can no longer provide meaningful service to its customer. The second customer service venue can be selected by, among other things, a predetermined order, a user selection, or an algorithm. Optionally, the user may be given a chance to confirm or alter the suggested customer service venue chosen by a predetermined order or an algorithm. In one embodiment, an intelligent algorithm can approximate the most helpful or most preferred customer service venue based on the user's customer service context. As an example, as the coordinator 204 can guide the user 202 through the various customer service venues 208, 212, 216 to resolve her problem, the coordinator 204 can adapt its course of venues to dynamically changing conditions at the various customer service venues 208, 212, 216, such as agent availability for the user's specific problem or in general. If, for instance, a call center has no available voice agent at the time the user 202 contacts their customer service operation, the coordinator 204 can automatically steer the user 202 to a customer service chat application.

Once a venue is chosen and the system 100 is notified of the movement of the user to the second venue, the system 100 transfers the context to the second customer service venue (422). The system can transfer the context from one venue to another by storing and/or updating context data in a centrally accessible server. Then the context is transferred when the second customer service venue polls the centrally accessible server and retrieves the stored context. The second customer service venue, similar to the first, can include, among others, a knowledge base, an online forum, a social network, a chat, and an onsite visit, but differs from the first venue in terms of its mode of interaction. As an illustration, the first customer service venue can be a social network, while the second customer service is a telephone conversation with a live customer service representative. In another example, a user may interact with an avatar of a customer service agent within an online virtual world such as Second Life®, exhaust all of the options, and transition to an on-site visit with a live customer service agent.

Again, the system 100 communicates with the user at the second customer service venue based on the context (424) similar to its interaction with the user at the first venue (418). The details of the context can be adapted for the specific communication modality at the current customer support venue based on customer preferences, and/or capabilities of a customer service agent's computing device if a customer service agent is present.

If there are no more venues available for the user to explore (426), then the customer service session ends. Additional venues can include venues in which the user has previously contacted customer support. Optionally, if the user decides to terminate the service (428), the session also ends. There can be other conditions, when met, that terminate the customer service session. If, however, none of these conditions are met, the system 100 can receive an indication of movement of the user from the second customer service venue to the third customer service venue (420). In some embodiments, however, determining whether there are additional venues to explore (426) and/or whether the user opts to end the service (428) can be one and the same as receiving an indication of movement (420). Once the user moves to the next customer service venue, the system 100 repeats the cycle by transferring the context to the third customer service venue (422) and communicating with the user at the third customer service venue based on the context (424). This cycle goes on until there are no more customer service venues left (426), the user wishes to end the service (428), or other conditions are met. The means by which the third and any subsequent venues are selected is similar to that of the second venue. These principles provide a continuous experience for a user that changes venues when resolving a customer support issue. The improved customer experience translates to a more satisfied customer and better public sentiment for the organization associated with the customer service.

Such method can lower the cost of customer service operations by improving their efficiency. For example, if a customer's identifying information and detailed service request is preserved across various venues, the live interaction between the customer service representatives and the customer will be shortened by the amount of time it takes to collect the identifying customer information and detailed service request. As a result, the number of live interactions that the involved agents can handle per time unit will increase, and the overall number of agents needed in the customer service operation will decrease, thus reducing cost.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
identifying a user profile associated with a user requesting customer service to yield a customer service request;
generating a context based on the user profile and the customer service request;
communicating with the user at a first customer service venue based on the context;
receiving an indication of movement of the user from the first customer service venue to a second customer service venue, wherein a mode of interaction of the second customer service venue differs from the first customer service venue;
transferring the context to the second customer service venue; and
communicating with the user at the second customer service venue based on the context.

2. The method of claim 1, wherein the user is a new user, wherein identifying the user profile further comprises:
receiving user information from the new user;
creating a new user profile; and
storing the new user profile in a database.

3. The method of claim 1, wherein the user is a returning user, wherein identifying the user profile further comprises:
authenticating the returning user; and
retrieving an existing user profile associated with the returning user from a database.

4. The method of claim 1, wherein the context is further based on at least one of a customer service history, and other data relevant to customer service.

5. The method of claim 1, wherein the user profile includes personal identifying information describing the user.

6. The method of claim 1, wherein the customer service request comprises at least one of a product, a customer service topic, a detailed description, a photograph, and an error log.

7. The method of claim 1, wherein each of the first customer service venue and the second customer service venue comprises a knowledge base, a troubleshooting guide, an online forum, a social network, an online virtual world, a text-based chat, a voice conversation, a video chat, a spoken dialog system, and an onsite visit.

8. The method of claim 1, wherein each of the first customer service venue and the second customer service venue has a respective degree of permissions to perform at least one of accessing and modifying the context.

9. The method of claim 1, wherein each of the first customer service venue and the second customer service venue is chosen based on at least one of a predetermined order, a user input, and an algorithm.

10. The method of claim 9, wherein the algorithm is based on the context and conditions of at least one of first customer service venue and the second customer service venue.

11. The method of claim 1, further comprising:
receiving an indication of movement of the user from the second customer service venue to a third customer service venue, wherein a mode of interaction of the third customer service venue differs from the second customer service venue;
transferring the context to the third customer service venue; and
communicating with the user at the third customer service venue based on the context.

12. A system comprising:
a processor;
a first module configured to control the processor to identify a user profile associated with a user requesting customer service to yield a customer service request, wherein the user profile includes personal identifying information describing the user;
a second module configured to control the processor to generate a context based on at least one of the user profile, the customer service request, a customer service history, and other data relevant to customer service;
a third module configured to control the processor to communicate with the user at a first customer service venue based on the context;
a fourth module configured to control the processor to receive an indication of movement of the user from the first customer service venue to a second customer service venue, wherein a mode of interaction of the second customer service venue differs from the first customer service venue;
a fifth module configured to control the processor to transfer the context to the second customer service venue; and
a sixth module configured to control the processor to communicate with the user at the second customer service venue based on the context.

13. The system of claim 12, wherein the user is a new user, wherein identifying a user profile further comprises:
receiving user information from the new user;
creating a new user profile; and
storing the new user profile in a database.

14. The system of claim 12, wherein the user is a returning user, wherein identifying the user profile further comprises:
authenticating the returning user; and
retrieving an existing user profile associated with the returning user from a database.

15. The system of claim 12, wherein each of the first customer service venue and the second customer service venue is chosen based on at least one of a predetermined order, a user input, and an algorithm based on the context.

16. The system of claim 12, further comprising:
a seventh module configured to control the processor to receive an indication of movement of the user from the second customer service venue to a third customer service venue, wherein a mode of interaction of the third customer service venue differs from the second customer service venue;
an eighth module configured to control the processor to transfer the context to the third customer service venue; and
a ninth module configured to control the processor to communicate with the user at the third customer service venue based on the context.

17. A non-transitory computer-readable storage medium storing instructions which, when executed by a computing device, cause the computing device to provide customer service at multiple customer service venues using a single context, the instructions comprising:
identifying a user profile associated with a user requesting customer service to yield a customer service request, wherein the user profile includes personal identifying information describing the user;
generating a context based on the user profile, the customer service request, a customer service history, and other data relevant to customer service;
communicating with the user at a first customer service venue based on the context;
receiving an indication of movement of the user from the first customer service venue to a second customer service venue, wherein a mode of interaction of the second customer service venue differs from the first customer service venue;
transferring the context to the second customer service venue; and
communicating with the user at the second customer service venue based on the context.

18. The non-transitory computer-readable storage medium of claim 17, wherein the user is a new user, wherein identifying a user profile further comprises:
receiving user information from the new user;
creating a new user profile; and
storing the new user profile in a database.

19. The non-transitory computer-readable storage medium of claim 17, wherein identifying the user profile further comprises:
authenticating the returning user; and
retrieving an existing user profile associated with the returning user from a database.

20. The non-transitory computer-readable storage medium of claim 17, the instructions further comprising:
receiving an indication of movement of the user from the second customer service venue to a third customer service venue, wherein a mode of interaction of the third customer service venue differs from the second customer service venue;
transferring the context to the third customer service venue; and
communicating with the user at the third customer service venue based on the context.
